(19) United States
(12) Patent Application Publication
(10) Pub. No.: US 2010/0126606 A1
(43) Pub. Date: May 27, 2010

(54) MICROFLUIDIC DEVICES

(76) Inventor: Gordon Robert Green, Bristol (GB)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 12/309,385

(22) PCT Filed: Jul. 12, 2007
(86) PCT No.: PCT/GB2007/002590

§ 371 Date: Feb. 12, 2010

Related U.S. Application Data
(60) Provisional application No. 60/831,718, filed on Jul. 17, 2006.

(30) Foreign Application Priority Data
Jul. 14, 2006 (GB) 0613996.8

(51) Int. Cl. F15C 3/00; G05D 7/00

(52) U.S. Cl. 137/596

(57) ABSTRACT

This invention relates to microfluidic devices including a manifold arrangement (1) with a terminal output channel (5) and a via (6) for connecting the terminal output (5) to the extreme end (11) of the manifold (1). The via (6) and channel (5) together form a bleed outlet. The shape of the via is such that it will always overlap the extreme end of the manifold, irrespective of the expected variability in via to manifold alignment. Preferably the manifold has a generally rectangular cross-section.

This invention relates to microfluidic devices.

In microfluidic devices, it's often necessary to have a common supply or return duct, which connects to more than one microfluidic device. If the common ducts and the parallel devices are fabricated within the single-layer, then the arrangement can be designed so as to avoid dead ends and regions of low flow speed. However, where more complex arrangements require the use of multiple layers of ducts, dead ends are unavoidable.

The consequence of dead ends and similar regions of low flow is that air, or other gas, can be trapped within the microfluidic system as the system is initially filled with wording fluid. Lack of flow in these regions means that the trapped air will not be satisfactorily swept through by fluid entering the system. Such air entrapment may be deleterious to the functioning of the microfluidic system.

Similarly, if a microfluidic system requires cleaning, either before or during cycles of use, then it would be flushed through using a suitable cleaning fluid. Dead ends and similar regions of low flow would not receive satisfactory cleaning, because of the low flow speed of cleaning fluid and, furthermore, if air is entrapped during the cleaning cycle, then such regions would not be cleaned at all.

A further consequence occurs after cleaning, when the microfluidic system is refilled with working fluid. Any remaining cleaning fluid needs to be flushed through by the flow of working fluid. Until all cleaning fluid is purged from the system, the contaminated working fluid would need to be discarded, particularly, for example, where the device was being used to process pharmaceuticals or food products. Regions of low flow speed would substantially extend the purge time and hence the amount of discarded working fluid.

FIG. 1 illustrates, schematically, such an arrangement wherein a manifold duct 1 is formed in a microfluidic device generally indicated at 10 and has via holes 2, which lead through an interposed solid layer of the device to a multiplicity of process devices (not shown) in a further layer. By this means working fluid is supplied to process device inlet paths 3, which are in parallel. Mechanical constraints may dictate that the holes 2 must not overlap the edge of the manifold duct 1. The finite alignment tolerance which can be achieved between these holes or vias 2 and the manifold duct 1, then dictate that the manifold duct must extend beyond the last via 2, creating a dead end at 4.

From one aspect the invention consists in a microfluidic device including an elongate manifold having an inlet and a plurality of process outlets spaced along its length and at least one normally closed end characterised in that the or each closed end is provided with a bleed outlet to enable purging of the manifold.

It would be usual for the inlet to be at the opposite end to the closed end, as illustrated in FIG. 1, but on occasions geometric and other constraints may demand that the inlet is between the ends of the manifold, in which case two closed ends would be present.

In a preferred embodiment the or each bleed outlet is sized to allow flow corresponding between 5% and 15% of the flow through a process outlet and a bleed outlet flow of around 10% is particularly preferred.

The manifold may be generally rectangular in cross-section and the or each bleed outlet may also be generally rectangular. By selecting the dimensions of the or each bleed outlet relative to the cross-sectional area of the manifold one can ensure that they are greater than the misalignment which arises from the manufacturing process for forming the manifold and the or each bleed outlet. This means that appropriate overlap will always occur. Preferably the manifold and the or each bleed outlet are formed by etching, particularly when the manifold is formed in a fluoropolymer or silicon substrate. Alternatively the bleed hole and manifold may be moulded or embossed.

In an alternative construction the or each bleed outlet may be constituted by a process outlet overlapping the closed end.

The device may include a plurality of manifolds and the bleed outlets may be connected or connectable to a recirculation path for re-circulating process fluid passing through the bleed outlets. This would only be appropriate when the device was in a processing condition.

In any one of the above arrangements at least one bleed outlet may have an associated valve.

Although the invention has been defined above it is to be understood it includes any inventive combination of the features set out above or in the following description.

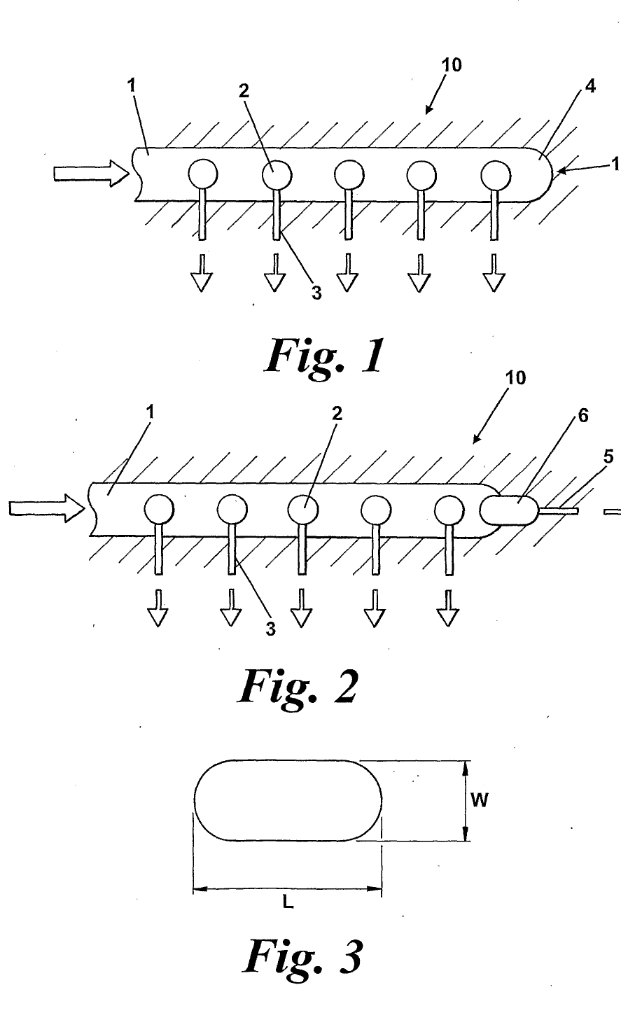

The invention may be performed in various ways and specific embodiments will now be described, by way of example with reference to FIGS. 2 to 4 of the accompanying drawings, in which;

FIG. 2 is a schematic view of a manifold of a microfluidic device incorporating a bleed outlet;

FIG. 3 indicates the shape and dimensions of such a bleed outlet; and

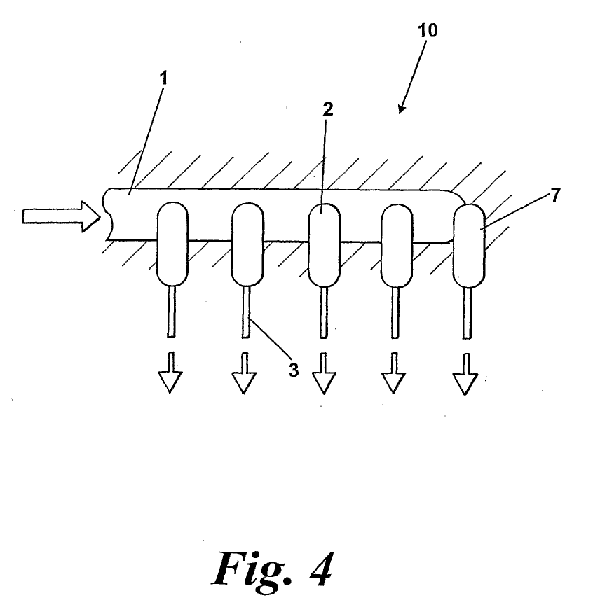

FIG. 4 is an equivalent drawing to FIG. 2, but of an alternative embodiment.

FIG. 2 shows the same manifold arrangement 1 as indicated in FIG. 1, but with the addition of a terminal output channel 5 and a via 6 for connecting the terminal output 5 to the extreme end 11 of the manifold 1. The via 6 and channel 5 together form a bleed outlet. The shape of the via is such that it will always overlap the extreme end of the manifold, irrespective of the expected variability in via to manifold alignment. Thus if the manifold has a generally rectangular cross-section, the via 6 can also desirably have a generally rectangular section.

As indicated in FIG. 3, the length L and the width W of the via 6, need to be chosen to be greater than the range of horizontal and vertical misalignment respectively between the via 6 and the manifold 1.

The dimensions of the terminal output channel 5 are chosen to determine the required flow of fluid through this channel. This would typically be chosen to be a small fraction (for example 10%) of the flow through a single process channel 3. If, as may well be the case, there were, for example, 100 process channels 3 connected to a single manifold 1, 0.1% of the total flow would pass through the terminal output channel. In the situation where air is being purged from the system, the flow of air through the terminal output channel 5 will be extremely rapid because of the much lower viscosity of air compared to typical liquids. In the situation where cleaning fluid is being purged from the system, a flow of typically 0.1% of the total flow is sufficient to avoid dead spots in the flow system and provide rapid purging. Similar argument pertains to the opposite case where the system has been flushed through with cleaning fluid. The result is that by losing 0.1% of the process fluid via the terminal output channel, a completely self-purging microfluidic system is formed without the complexities of additional bleed valves. However if the process fluid was a very high value, then a valve could be used to control the flow through the terminal output channel and indeed the bled fluid, during proper processing, could be re-circulated to source.

A further variant, which avoids loss of fluid through the terminal output channel, is where the terminal output channel can be an actual device channel. This would be possible whenever the detailed design of the system allows the via to overlap the edge of the manifold.

Such an arrangement is shown in FIG. 4. The terminal output channel is replaced by an actual device channel is via 7 overlaps the extreme end of the manifold under all conditions of via to manifold misalignment, as described above.

In all of the above arrangements, it is advantageous if the end of the manifold 1 is rounded so as to avoid angular corners, which would of themselves create stagnation points within the fluid flow.

1. A microfluidic device including an elongate manifold having an inlet, plurality of process outlets spaced along its length and at least one normally closed end characterised in that the or each closed end is provided with a bleed outlet to enable purging of the manifold.

2. A device as claimed in claim 1 wherein the or each bleed outlet is sized to allow flow corresponding between 5% and 15% of the flow through a process outlet.

3. A device as claimed in claim 1 wherein the manifold is generally rectangular in cross-section and the or each bleed outlet is generally rectangular.

4. A device as claimed in claim 3 wherein the dimensions of the or each bleed outlet are greater than the misalignment which arises from the manufacturing process for forming the manifold and the or each bleed outlet.

5. A device as claimed in claim 4 wherein the manifold is formed in a silicon fluoropolymer substrate and the manifold and the or each bleed outlet are formed by etching, moulding or embossing.

6. A device as claimed in claim 1 wherein the or each bleed outlet is constituted by a process outlet overlapping the closed end.

7. A device as claimed in claim 1 further including a plurality of manifolds and wherein the bleed outlets are connected or connectable to a recirculation path for recirculating process fluid passing through the bleed outlets.

8. A device as claimed in claim 1 wherein in at least one bleed outlet has an associated valve.

9. A device as claimed in claim 2 wherein the manifold is generally rectangular in cross-section and the or each bleed outlet is generally rectangular.

10. A device as claimed in claim 9 wherein the dimensions of the or each bleed outlet are greater than the misalignment which arises from the manufacturing process for forming the manifold and the or each bleed outlet.

11. A device as claimed in claim 3 wherein in at least one bleed outlet has an associated valve.

12. A device as claimed in claim 3 further including a plurality of manifolds and wherein the bleed outlets are connected or connectable to a recirculation path for recirculating process fluid passing through the bleed outlets.
